(19) United States
(12) Patent Application Publication
(10) Pub. No.: US 2009/0215621 A1
(43) Pub. Date: Aug. 27, 2009

(54) COLORING SYSTEM WITH ENCAPSULATED DYES

(75) Inventor: Sandra Lynn Jackson, Gahanna, OH (US)

Correspondence Address: MCNEES WALLACE & NURICK LLC, 100 PINE STREET, P.O. BOX 1166, HARRISBURG, PA, 17108-1166, US

(73) Assignee: ELMER'S PRODUCTS, INC., Columbus, OH (US)

(21) Appl. No.: 12/038,425

(22) Filed: Feb. 27, 2008

(51) Int. Cl. B41M 5/136

(52) U.S. Cl. 503/201; 503/200; 503/220

(57) ABSTRACT

A method for creating color images is provided. This method includes providing at least one color precursor, wherein the color precursor is contained within microcapsules of predetermined sizes or variable sizes; providing a substrate, wherein the substrate is coated with at least one-color-triggering developer; depositing the microcapsules on the surface of the substrate; and creating an image on the substrate by applying pressure to the microcapsules in a controlled manner, wherein the pressure is sufficient to rupture the microcapsules, wherein rupturing the microcapsules releases the color precursor for reacting with the color-triggering developer, and wherein the reaction of the color precursor with the color-triggering developer creates color on the surface of the substrate.

### BACKGROUND OF THE INVENTION

The described invention relates in general to a system and kit for creating two-dimensional images on a surface, and more specifically to a system for creating colorful, finger-painted images on a specific substrate without creating a mess.

Finger painting has long been recognized as a favorite activity of young children. While fun for the child, finger painting is typically a very messy activity and usually requires the close supervision of adults. As most parents can attest, children will often paint on many surfaces such as tables, walls, and even themselves, instead of on more desirable surfaces. Furthermore, the paints or inks used for finger painting are often difficult to remove and unless the area in which the child is painting is covered with protective material, permanent staining or damage to various surfaces may occur.

Marking systems that provide “mess-free” coloring have been developed and commercialized. Systems such as the “Go Paint” product (Elmer's Products, Inc., Columbus, Ohio) include markers or brushes that contain colorless solutions of leuco dye intermediates that react with specially coated paper provided with the markers or brushes. While attractive and effective for their intended purpose, such systems typically involve the use of only liquid ink, which is not suitable for finger painting, and which may still find its way onto clothes or other surfaces where it may produce undesired color, particularly after clothes are washed.

Thus, while various “mess-free” systems are known in the art for creating colorful images on substrate, a need still exists for a coloring system that will provide a child with the opportunity to create colorful images with their fingers as opposed to a marker, and that will provide parents with an easy clean up after the painting activities have ceased.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a system for creating colorful images is provided. This system includes at least one color precursor, wherein the color precursor is contained within microcapsules of predetermined size or range of sizes; a substrate adapted to receive the microcapsules on the surface thereof wherein the surface of the substrate is coated with at least one color-triggering developer; means for applying force to the microcapsules sufficient to rupture the polymer micro-particles; and wherein rupturing the microcapsules releases the color precursor for reacting with the color-triggering developer, and wherein the reaction of the color precursor with the color-triggering developer creates color on the surface of the substrate.

In accordance with another aspect of the present invention, a system for creating colorful images on a specific substrate is provided. This system includes at least one leuco-dye color precursor, wherein the color precursor is contained within small capsules or “microcapsules” having a diameter of about 5-50 microns or greater; a substrate adapted to receive the microcapsules on the surface thereof wherein the surface of the substrate is coated with at least one color-triggering developer, and wherein the at least one color-triggering developer further includes at least one Lewis acid; an object for applying mechanical force to the microcapsules in a controlled manner and in an amount sufficient to rupture the polymer micro-particles; and wherein rupturing the microcapsules releases the color precursor for reacting with the color-triggering developer, and wherein the reaction of the color precursor with the color-triggering developer creates color on the surface of the substrate.

In yet another aspect of this invention, a method for creating color images is provided. This method includes providing at least one color precursor, wherein the color precursor is contained within microcapsules of predetermined size or variable sizes; providing a substrate, wherein the substrate is coated with at least one-color-triggering developer; depositing the microcapsules on the surface of the substrate; and creating an image on the substrate by applying pressure to the microcapsules in a controlled manner, wherein the pressure is sufficient to rupture the microcapsules, wherein rupturing the microcapsules releases the color precursor for reacting with the color-triggering developer, and wherein the reaction of the color precursor with the color-triggering developer creates color on the surface of the substrate.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the following description is to be regarded as illustrative and not restrictive in nature.

### DETAILED DESCRIPTION OF THE INVENTION

Exemplary embodiments of the present invention are described below. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates to a color change system that utilizes encapsulated leuco dye intermediates as color precursors. As previously indicated, a first general embodiment of this invention provides a system for creating colorful images using a colorless ink in a powered form; a second general embodiment of this invention provides a system for creating colorful images on a specific substrate using a colorless ink in a powered form deposited on a coated substrate; and a third general embodiment of this invention provides a method for creating color images using a finger painting-like technique. With reference now to the Figures, one or more specific embodiments of this invention shall be described in greater detail.

An exemplary embodiment of the present invention includes two basic components. The first basic component includes a microencapsulated dye and the second component includes a coated substrate which is reactive with the dye contained in the microcapsules. In this embodiment the microencapsulated dye further includes at least one color precursor in the form of a leuco dye intermediate. In general terms, a leuco dye is a dye whose molecules can acquire two forms, one of which is colorless. Leuco dyes are typically found in a liquid state and are colorless until reacted with a color-triggering activator. Leuco dye intermediates are sensitive to oxidation and/or acidic environments. Examples of leuco dyes include, diarylphthalide dyes, fluoran dyes, indolyphthalide dyes, acylluecoazine dyes, leucoauramine dyes, spiropyrane dyes, rhodaminelactam dyes, triarylmethane dyes and chromene dyes. Leuco dyes that produce color under acidic conditions, such as triphenylmethanes, diphenylmethanes, xanthenes, thiazines, spiropyranes and the like, are particularly suitable for use with the present invention.

As previously stated, the color precursor of the present invention is contained within a plurality of microcapsules of predetermined size or sizes or of variable sizes. The microcapsules of this invention may be about 1-3000 μm in diameter, although other more specific sizes are possible, such as 5-20 μm. Particle size distribution may be substantially uniform in some formulations or relatively non-uniform in other formulations. In an exemplary embodiment, manufacturing microcapsules involves the precipitation of a gelatin or synthetic polymer shell around a hydrophobic core material and/or a liquid solvent, containing the color precursor. The outer shell of the microcapsule may be made from any suitable material such as gelatin or one or more synthetic polymers. Examples of non-toxic polymers compatible with this invention include polyoxymethylene urea (PMU) or a methoxymethyl methylol melamine (MMM). Microcapsules may be manufactured according to one or more known methods including, for example, in-situ polymerization, interfacial polymerization, and coacervation encapsulation. Encapsulation of the color precursor may be accomplished by processes such as those described in U.S. Pat. Nos. 3,016,308; 3,429,827; 3,578,605; and 5,225,278, each of which is incorporated herein by reference, in its entirety. Microcapsules containing color precursors may also be provided as a dry free flowing powder (see U.S. Pat. No. 3,016,308), and in some embodiments of this invention, this power is mixed with a mineral oil or similar substance and compacted to provide a convenient means for storing the powder prior to and during use.

Having generally described the microencapsulated color precursor component of this invention, a further understanding can be obtained by reference to a specific example detailed below, which is provided for purposes of illustration only and is not intended to be all inclusive or limiting unless otherwise specified.

EXAMPLE

| Component | Weight % |
|---|---|
| Corn Starch | 39.7 |
| Microparticles/Microcapsules/Capsules | 50.0 |
| (containing color precursor) | |
| Magnesium Stearate | 10.0 |
| Methylparaben | 0.20 |
| Propylparaben | 0.10 |

In this Example, the microparticles, microcapsules, or capsules that contain a color precursor (which may be precursors to any of a variety of colors including green, brown, pink, red, blue, slate, and purple) are formulated with corn starch as a binder, magnesium stearate as a filler and lubricant, and methylparaben and polyparaben as preservatives. Mineral oil or another similar substance may be included to allow the formula to be compressed or otherwise compacted. The leuco dye included in the capsule determines the color that will ultimately appear on the substrate coated with the color triggering developer.

The substrate component of this invention is coated with a color-triggering developer, which may be coated on one or both sides of the substrate and which typically includes at least one Lewis Acid. Acidic ingredients that are useful as color-triggering developers when reacted with various leuco dye intermediates include bentonite, zinc oxide, kaoline, clay, active clay, acid clay, zeolite, talc, colloidal silica, phenol-aldehyde resin, maleic acid-rosin resin, bis-phenol A, bis-phenol S, metal salts of organic acids, such as zinc salicylate and/or combinations thereof. Suitable color-trigger developers that comprise at least one Lewis Acid are disclosed in U.S. Pat. Nos. 5,485,974 and 6,124,377, which are incorporated by reference herein, in their entirety. Substrates that can be coated with the color-triggering developer include paper, cardboard, pasteboard, clay, plastic and numerous other materials. Suitable reactive substrates are commercially available from NuCoat, Inc., (Plymouth, Minn.); Miami Wabash Paper (West Chester, Pa.); and Technicote, Inc. (Miamisburg, Ohio), among others.

As previously indicated, the present invention provides a method for creating color images. This method includes providing at least one color precursor, wherein the color precursor is contained within microcapsules of predetermined size or variable sizes; providing a substrate, wherein the substrate is coated with at least one-color-triggering developer; depositing the microcapsules on the surface of the substrate; and creating an image on the substrate by applying pressure to the microcapsules in a controlled manner, wherein the pressure is sufficient to rupture the microcapsules, wherein rupturing the microcapsules releases the color precursor for reacting with the color-triggering developer, and wherein the reaction of the color precursor with the color-triggering developer gradually creates color on the surface of the substrate. To use the present invention as a “finger painting” system, the user simply deposits an amount of a colorless microencapsulated dye (specific to a particular color) on the substrate and applies mechanical pressure thereto while at the same time drawing an image or design with the tip of a finger. Alternately, in the embodiment of this invention wherein the microencapsulated dye is provided in a compressed form, the user dips his or her fingertip into a reservoir containing the colorless dye and transfers an amount of the dye to thereto. The user then places his or her fingertip on the coated substrate and applies downward pressure sufficient to rupture the microcapsules and bring the encapsulated dye into contact with the color triggering substrate. As the reaction between the color precursor and the color triggering substrate occurs, color gradually forms on the substrate in the pattern created by the user.

Because the color precursor only reacts with the coated substrate, the fingertip of the user, or any other implement or applicator used to apply the color precursor to the substrate will remain substantially free of color, unless contacted with a Lewis acid or other appropriately acidic material. Thus, after the user has finished creating colorful images on the substrate the only clean up that is necessary is vacuuming or brushing away any extraneous unreacted color precursor-containing powder.

This invention may be packaged as a commercial product in the form of a kit that contains multiple sheets of substrate, a selection of color precursor powders (either in loose form or compressed/compacted form) corresponding to a variety of colors, and a set of instructions. This kit may include one or more specially designed applicators that may be used to apply the color precursor powders to the substrate if the use of fingers is deemed undesirable.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A system for creating colorful images, comprising:
(a) at least one color precursor, wherein the color precursor is contained within microcapsules of predetermined size;
(b) a substrate adapted to receive the microcapsules on the surface thereof wherein the surface of the substrate is coated with at least one color-triggering developer;
(c) means for applying force to the microcapsules sufficient to rupture the polymer micro-particles;
(d) wherein rupturing the microcapsules releases the color precursor for reacting with the color-triggering developer, and wherein the reaction of the color precursor with the color-triggering developer creates color on the surface of the substrate.

2. The system of claim 1, wherein the at least one color precursor further comprises at least one leuco dye.

3. The system of claim 1, wherein the microcapsules that contain the color precursor are provided in a loose powder form.

4. The system of claim 1, wherein the microcapsules that contain the color precursor are provided in compacted powder form.

5. The system of claim 1, wherein the microcapsules are about 5-20 μm in diameter.

6. The system of claim 1, wherein the at least one color-triggering developer further comprises at least one Lewis acid.

7. The system of claim 1, wherein the color precursor and substrate are provided in a kit, and wherein the kit includes:
(i) an optional applicator for use with the color precursor; and
(ii) a set of instructions.

8. A system for creating colorful images on a substrate, comprising:
(a) at least one leuco-dye color precursor, wherein the color precursor is contained within microcapsules having a diameter of about 1-3000 μm;
(b) a substrate adapted to receive the microcapsules on the surface thereof wherein the surface of the substrate is coated with at least one color-triggering developer, and wherein the at least one color-triggering developer further includes at least one Lewis acid;
(c) an object for applying mechanical force to the microcapsules in a controlled manner and in an amount sufficient to rupture the polymer micro-particles;
(d) wherein rupturing the microcapsules releases the color precursor for reacting with the color-triggering developer, and wherein the reaction of the color precursor with the color-triggering developer creates color on the surface of the substrate.

9. The system of claim 8, wherein the microcapsules that contain the color precursor are provided in a loose powder form.

10. The system of claim 8, wherein the microcapsules that contain the color precursor are provided in compacted powder form.

11. The system of claim 8, wherein the substrate further comprises paper.

12. The system of claim 8, wherein the object for applying mechanical force to the microcapsules is a human finger.

13. The system of claim 1, wherein the color precursor and substrate are provided in a kit, and wherein the kit includes:
(i) an optional applicator for use with the color precursor; and
(ii) a set of instructions.

14. A method for creating color images, comprising:
(a) providing at least one color precursor, wherein the color precursor is contained within microcapsules of predetermined size;
(b) providing a substrate, wherein the substrate is coated with at least one-color-triggering developer;
(c) depositing the microcapsules on the surface of the substrate; and
(d) creating an image on the substrate by applying pressure to the microcapsules in a controlled manner, wherein the pressure is sufficient to rupture the microcapsules, wherein rupturing the microcapsules releases the color precursor for reacting with the color-triggering developer, and wherein the reaction of the color precursor with the color-triggering developer creates color on the surface of the substrate.

15. The method of claim 14, further comprising providing the color precursor and substrate are in a kit, wherein the kit includes an optional applicator for use with the color precursor; and a set of instructions.

16. The method of claim 14, wherein the at least one color precursor further comprises at least one leuco dye.

17. The method of claim 14, wherein the microcapsules that contain the color precursor are provided in a loose powder form.

18. The method of claim 14, wherein the microcapsules that contain the color precursor are provided in compacted powder form.

19. The method of claim 14, wherein the microcapsules are about 5-20 μm in diameter.

20. The method of claim 14, wherein the at least one color-triggering developer further comprises at least one Lewis acid.
